(19) United States
(12) Patent Application Publication
(10) Pub. No.: US 2013/0273312 A1
(43) Pub. Date: Oct. 17, 2013

(54) Method of Fastening Parts to a Composite Part

(71) Applicant: FORD GLOBAL TECHNOLOGIES, LLC, Dearborn, MI (US)

(72) Inventors: Aindrea McKelvey Campbell, Beverly Hills, MI (US); Daniel Quinn Houston, Dearborn, MI (US); Amanda Kay Freis, Ann Arbor, MI (US)

(73) Assignee: FORD GLOBAL TECHNOLOGIES, LLC, Dearborn, MI (US)

(21) Appl. No.: 13/744,920

(22) Filed: Jan. 18, 2013

Related U.S. Application Data
(63) Continuation-in-part of application No. 13/448,464, filed on Apr. 17, 2012.

(51) Int. Cl. B32B 7/08; B32B 3/26; B23P 11/00

(52) U.S. Cl. CPC B32B 7/08; B23P 11/00; B32B 3/266; B32B 3/263
USPC 428/137; 29/525.11; 29/525.01; 428/162

(57) ABSTRACT

A method of joining parts together with a flow drill screw or with a clinch joint. A first part formed of metal or a composite material is joined to a second part that includes a fiber-filled layer and a resin matrix layer. The flow drill screw extends through the first part and the second part into the second part. The resin matrix layer prevents fibers from the fiber filled layer from being forced through the back of the second panel. A clinch joint may be formed into the first part and the second part but does not penetrate completely through the resin matrix layer. When the clinch joint is formed, the resin matrix layer inhibits the fiber filled layer from pushing through the second layer of the second panel.

### CROSS-REFERENCE TO RELATED APPLICATIONS

This application is a continuation-in-part of U.S. application Ser. No. 13/448,464 filed Apr. 14, 2012, the disclosure of which is incorporated in its entirety by reference herein.

### TECHNICAL FIELD

This disclosure relates to riveting, clinching or flow drill screwing parts or panels to a composite part formed from a layered resin and a fibrous filler material.

### BACKGROUND

As the automotive industry continues to focus on reducing the weight of vehicles to meet customer expectations on fuel economy and CAFE requirements, interest in alternative materials including carbon fiber composite applications has increased. In body-in-white structures, joining methods have traditionally relied on resistance-spot welding (e.g., in steel structures). In the case of aluminum intensive vehicles and other mixed metal joining applications, self-piercing rivet (SPR) technology prevails. One advantage of SPR technology is that it is a high production volume assembly process. Further, it is compatible with adhesive, where both methods can be used in conjunction. The challenge often faced with SPR however, is that the substrate material must be ductile enough to form a “button”, i.e., protrusion, which is the result of creating the joint and the necessary deformation to provide mechanical interlock. When composite parts do not have sufficient ductility to form a button on the obverse side, fibers may be exposed through cracks in this surface. Surface cracking and fiber displacement are undesirable, as they may reduce the durability of the joint and result in premature failure.

In addition to SPRs, other joining technologies are available for joining parts to fiber reinforced composite parts. Flow drill screws may be driven through a part, either a first metal or composite part and into the fiber reinforced composite part. As the flow drill screw is driven through the part, an extruded bushing is formed on the exit side of the second composite part and can expose fibers. The exposed fibers can reduce the robustness of the joint. Clinch joints may be used to join parts to a fiber reinforced composite part but the clinching operation may result in fibers being pushed through the back side of the composite part and the resin may fracture as the fibers are pushed through the back side.

Composite materials, such as carbon fiber, glass fiber or natural fiber composites, can be limited in application due to challenges relating to joining parts together. Frequently, these composites have limited ductility and are not well adapted to large displacements and deformation required to produce a button or bushing on the back side of the composite part. While adhesive has been used extensively in the past to join composite parts together, adhesive joining is a lower volume production method when used in isolation and is susceptible to displacement (i.e., movement between the parts to be joined) until the adhesive is cured. Blind rivets may be used to fasten parts to a composite component but it is necessary to first drill or pre-form a hole through the parts to insert the blind rivet. Assembly operations for drilling holes, aligning the holes, inserting the blind rivet and affixing the rivet add to the cost of assembly and the cost of tooling. A joining solution is needed that meets high volume production requirements and enables joining in a low ductility material.

This disclosure is directed to overcoming the above problems and other problems associated with the use of composite parts in applications where other parts are joined to a composite part.

### SUMMARY

One method of joining a part to a composite part is to drive a flow drill screw (hereinafter “FDS”) through the part and into a composite part with a flow drill screw driver. The FDS approach may be performed when access to the assembly of parts is provided on only one side of the assembly.

An alternative method of joining a part to a composite part is to form a clinch joint. Clinch joints are formed by a set of tools that include a clinch punch and a back-up die. Clinch joints may be used only if access is provided to two sides of the assembly.

According to one aspect of this disclosure, a method of joining a part to a composite material part is disclosed. According to the method, a first part is selected and a second part is selected that includes a first layer of a resin matrix that is reinforced with a filler material and a second layer of a resin matrix that does not include the filler material on at least part of one side of the second part. The first and second parts are secured together with a FDS or a clinch joint formed by a punch tool and a back-up. The first layer of the second part that includes resin and reinforcement fibers is contained by the second layer of the second part that includes resin but no added reinforcement fibers. The second layer prevents the reinforcement fibers in the first layer from penetrating the second layer.

According to other aspects of the disclosure, the method further comprises forming the second part in a compression molding die by placing the filler material including a fiber reinforcement and a resin matrix into the compression molding die. The method may further comprise depositing the resin matrix into the compression molding die in two steps. In one step, the resin is deposited in the compression molding die to encase the filler material in the first layer. In another step, the resin is deposited in the compression molding die in the second layer. In another approach, the method may further comprise providing a textured surface on a predetermined portion of the compression molding die where the second layer is formed. The textured surface inhibits the filler material from becoming part of the second layer. Following either approach, the second layer may be more than 3 microns thick.

According to another aspect of the disclosure, an assembly may be provided that includes a first part and a second part formed of a composite material that is joined together with a FDS or a clinch joint. The FDS extends through the first part and the second part. The clinch joint does not include a fastener but joins the parts by driving a portion of the first part into the second part, creating a mechanical interlock between the two parts. The mechanical interlock is formed by the punch and back-up die geometry. The second part has a first layer of a resin matrix that is reinforced with filler and a second layer of a resin matrix that does not include the filler on at least part of one side of the second part.

The filler material is not exposed on a side of the second part that is opposite the first part after insertion of the FDS or formation of the clinch joint. The filler may be a fiber reinforcement that is randomly deposited or aligned in the resin matrix. The second layer of the second part may be provided in localized areas on the first layer where the FDS or the clinch joint is formed.

These and other aspects of the disclosure will be better understood in view of the attached drawings and the following detailed description of the disclosed embodiments.

### BRIEF DESCRIPTION OF THE DRAWINGS

FIGS. 1A-1D are a series of diagrammatic views illustrating the manufacturing process for inserting a self-piercing rivet with a self-piercing rivet tool into two panels beginning with the initial set up through completion of the riveting process;

FIG. 2 is a diagrammatic view showing one rivet in position to be inserted into a metal part and a composite part;

FIG. 3 is a fragmentary cross-sectional view showing a self-piercing rivet inserted through a first panel and into a second composite material panel having added resin matrix;

FIG. 4 is a perspective view partially in cross section showing the obverse side of a pair of panels joined with self-piercing rivets in areas having additional resin matrix material;

FIG. 5 is a diagrammatic view showing FDS in position to be inserted into a metal part and a composite part;

FIG. 6 is a fragmentary cross-sectional view showing a FDS inserted through a first panel and into a second composite material panel having added resin matrix;

FIG. 7 is a diagrammatic view showing a clinch joint forming tool in position prior to joining a metal part and a composite part; and

FIG. 8 is a fragmentary cross-sectional view showing a clinch joint made through a first panel and into a second composite material panel having added resin matrix.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

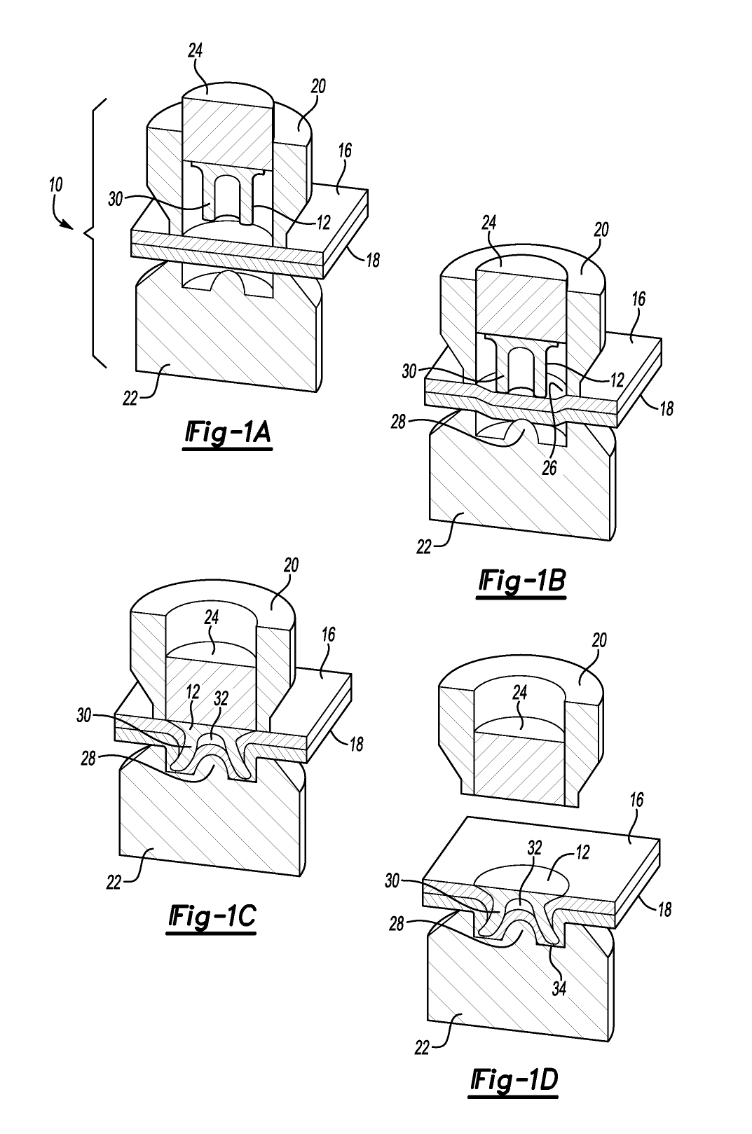

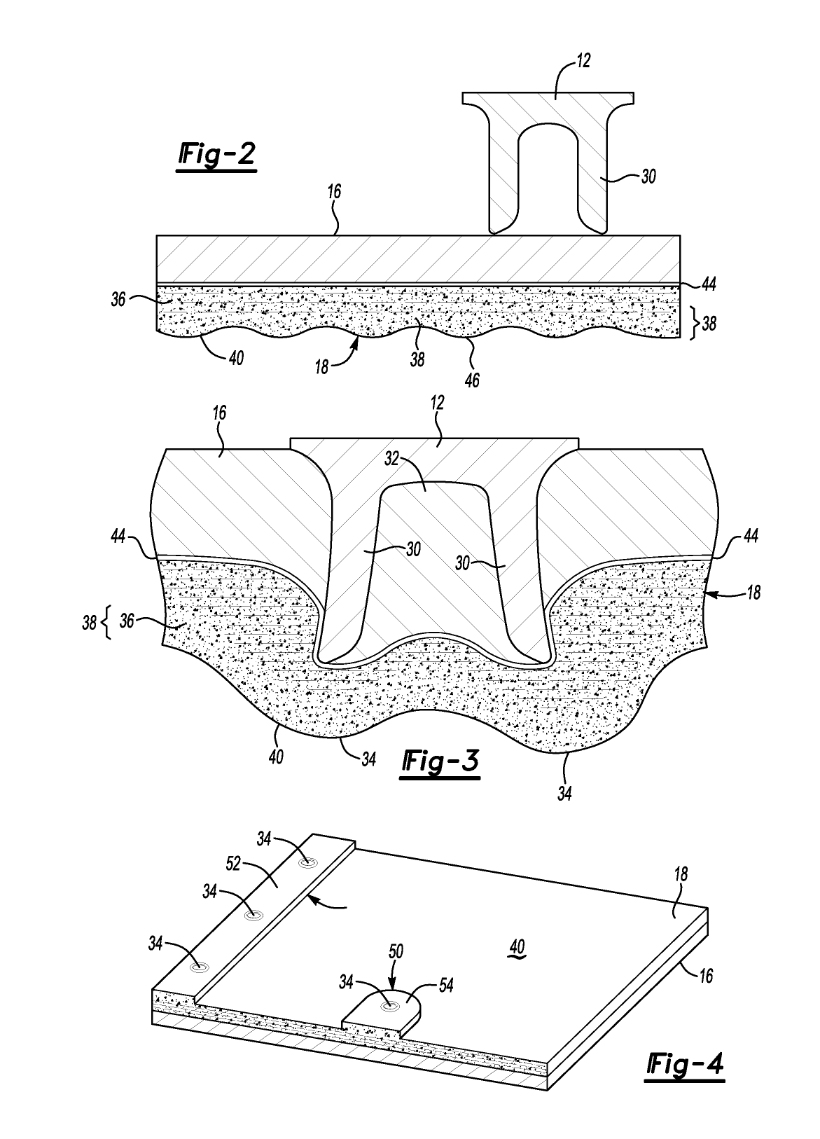

Referring to FIGS. 1A-1D, a self-piercing rivet tool is generally identified by reference numeral 10. The self-piercing rivet tool 10 is used to insert a self-piercing rivet 12 (hereinafter “SPR”) into a first panel or part 16 and a second panel or part 18. The first panel may be a steel, aluminum or other metal panel or may alternatively be a composite part, such as, an SMC composite panel including a fiber reinforced resin. The second panel or part 18 is a composite panel that is preferably provided with additional matrix material on the lower side of the panel 18. The structure of the second panel 18, or part, is described more specifically with reference to FIGS. 2-4.

The first and second panels 16 and 18 are shown in FIG. 1A to be retained between a blank holder 20 and a die 22 that engage opposite sides of the stack of panels. Additional panels may be provided of various compositions. This disclosure is intended to include stacks of three, four or more panels of various thicknesses and compositions. The die 22 backs up the panels 16 and 18 as the punch 24 drives the rivet.

Referring to FIG. 1B, the first part of the riveting process is illustrated wherein an indentation 26 is formed in the panels 16 and 18 that are driven into a pip 28 formed in the die 22. While a pip 28 is shown in the illustrated embodiment, a die 22 having a flat surface could also be employed in the disclosed process. The rivet 12 includes a hollow tubular portion 30 that is driven into the first and second panels 16 and 18 to join the panels together.

Referring to FIG. 1C, the rivet 12 is shown fully inserted into the first and second panels 16 and 18 with the punch 24 driving the rivet 12 until it is flush with the first panel 16. The blank holder 20 continues to apply pressure to the first panel 16 while the tubular portion 30 of the rivet 12 is driven through the first panel 16 and into the second or composite panel 18. A slug 32 is separated from the first panel 16 and retained within the hollow tubular portion 30 of the rivet 12 when the self-piercing rivet is inserted into the panels 16 and 18. The hollow tubular portion 30 is shown in an expanded condition after it is driven over the pip 28 that is covered by the second panel 18.

Referring to FIG. 1D, the blank holder 20 and punch 24 are shown being lifted off the first panel 16 after having inserted the rivet 12 through the first panel 16 and into the second panel 18. A button 34 is formed by the rivet 12. The button 34 is formed by the rivet 12 as it is inserted through the first panel 16 and partially through the second panel 18. The rivet 12 and joined panels 16 and 18 are shown in position to be removed from the die 22.

Referring to FIG. 2, a single rivet 12 is shown above two panels 16 and 18 that are ready to be joined by insertion of the rivet 12. A fiber filled layer 36 includes randomly distributed fibers and filler. The fiber filled layer 36 may include a carbon fiber, glass fiber, mica, or natural fiber filler material that may be arranged as a random composite or loose filler material. The fiber filled layer 36 is encased in a resin matrix. The resin matrix may be a thermoplastic or thermoset resin. A matrix layer 38 is provided adjacent the fiber filled layer 36 on the obverse side 40 of the second panel 18. The term “obverse side” as used herein is intended to identify the side of the stack of panels that is opposite the side through which the rivet 12 is inserted. The matrix layer 38 is preferably three microns or more in thickness to provide a flexible non-brittle layer into which the tubular portion 30 of the rivet 12 may extend. A top layer 44 may be provided above the fiber filled layer 36 that may be approximately 1 to 2 microns thick. As illustrated, the thickness of the layers 38 and 44 are exaggerated to be visible in the drawings. The top layer 44 is provided to assure a smooth surface on the panel, as required.

A textured surface 46 may be provided on the obverse side 40 of the second panel 18. The textured surface 46 may serve to prevent fiber filler material from moving too close to the obverse side 40 in the molding or panel forming process. The textured surface 46 permits additional resin accumulating to 3 microns or more to form a relatively pure matrix mix adjacent the obverse side 40. The textured surface 46 may be provided over the entire surface of the second panel 18 or may be provided in localized areas.

Referring to FIG. 3, a rivet 12 is shown inserted through a first panel 16 and into the second panel generally indicated by reference numeral 18. The second panel 18 is preferably a composite material, such as an SMC, injection molded, compression molded, or Vartum liquid vacuum assist manufactured panel. As the rivet 12 is inserted, a slug 32 is severed from the first panel 16. The slug 32 locks the tubular portion 30 of the rivet 12 into an expanded condition and interlocks with the fiber filled layer 36 of the second panel 18. The matrix layer 38 facilitates forming a smooth button 34 on the obverse side 40 of the second panel 18. Fibers in the fiber filled layer 36 may be displaced upon insertion of the tubular portion 30 of the rivet 12 but any displaced fibers are held within the panel by the matrix layer 38.

Referring to FIG. 4, a first panel 16 is shown below a second panel 18. The first and second panels are inverted in comparison to the other views presented above to illustrate the two areas having added matrix material in localized areas. An edge area 52 is shown in which additional resin is provided to permit joining the two panels together with rivets 12 (shown in FIGS. 1-3). The rivets 12 upon insertion form buttons 34 on the edge area 52. In a similar manner, a single rivet area 54 is shown that is partially or wholly circular and may be provided in a particular localized area to receive a single rivet 12 (shown in FIGS. 1-3). By providing only localized areas 52, 54 of added matrix, the weight of the second panel 18 may be minimized while providing a matrix layer 38 in which well-formed and smooth buttons 34 may be formed on the obverse side of the second panel 18.

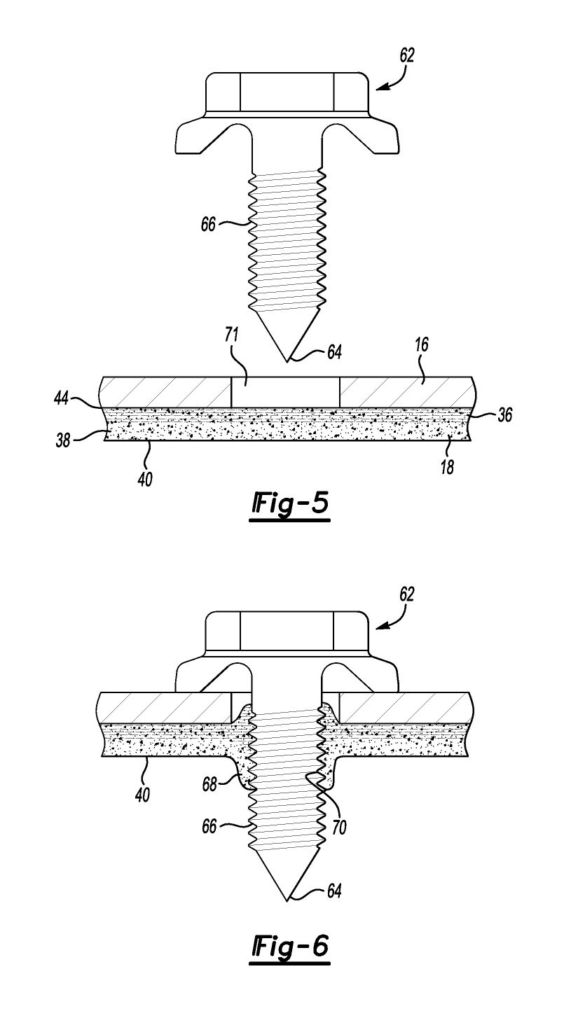

Referring to FIG. 5, a FDS 62 is shown above two panels 16 and 18 that are ready to be joined by insertion of the FDS 62. The fiber filled layer 36 includes randomly distributed fibers and filler. The fiber filled layer 36 may include fiber filler material as previously described that may be arranged as a random composite or loose filler material. The fiber filler is encased in a resin matrix that may be a thermoplastic or thermoset resin. The matrix layer 38 is provided adjacent the fiber filled layer 36 on the obverse side 40 of the second panel 18. The matrix layer 38 provides a flexible layer through which the FDS 62 may extend. The thickness of the layers 38 and 44 are exaggerated to be visible in the drawings. The top layer 44 is provided to assure a smooth surface on the panel, as required.

Referring to FIG. 6, a FDS 62 is shown inserted through a first panel 16 and through the second panel 18. As the FDS 62 is inserted, the tip of the screw 64 frictionally heats the panels 16 and 18 until the threaded shaft 66 of the FDS 62 is received by the panels 16 and 18. A bushing 68 is formed on the matrix layer 38 of the second panel 18 and internal threads 70 are formed by the self-tapping action of the threads of the FDS 62. The bushing 68 receives the FDS 62 and interlocks with the fiber filled layer 36 of the second panel 18. The matrix layer 38 provides the bushing 64 with a smooth surface on the obverse side 40 of the second panel 18. Fibers in the fiber filled layer 36 may be displaced upon insertion of the FDS 62 but any displaced fibers are held within the panel by the matrix layer 38.

A clearance hole 71 is provided in the first panel 16 that may be provided if the first panel is relatively thick or has substantial yield strength properties. However, it should be understood that depending on the thickness and material properties of the top layer 16 no clearance hole 71 may be necessary.

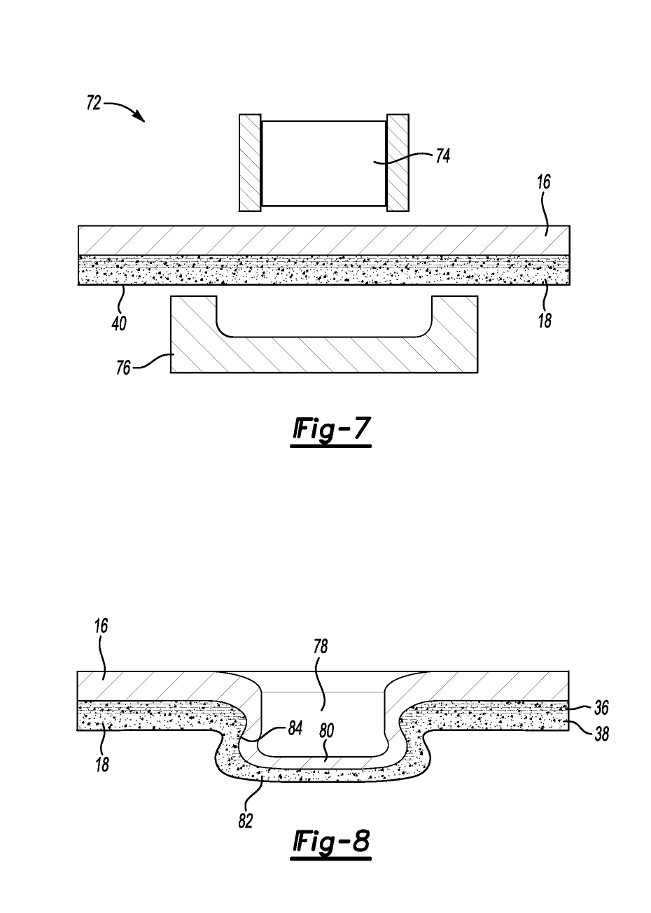

Referring to FIG. 7, a clinch joining tool 72 is illustrated that includes a punch 74 on one side of the first panel 16 and the second panel 18. A die 76 is positioned on the obverse side 40 of the second panel 18.

Referring to FIG. 8, the panels 16 and 18 are shown to be joined together with a clinch joint 78. The punch 74 (shown in FIG. 7) is driven into the first panel 16 to displace a circular portion 80 of the first panel 16 into a corresponding displaced portion 82 of the second panel 18. The reaction force applied by the die button 76 creates an undercut area 84 that is formed on the second panel 18 that locks the two panels 16 and 18 together.

The matrix layer 38 restrains the reinforcement fibers in the fiber filled layer 36 from being forced through the obverse side 40 of the second panel 18. As a result, the displaced portion 82 of the second panel 18 remains smooth even after the clinch joint 78 is formed.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
selecting a first part;
selecting a second part including a first layer of a resin reinforced with a filler and a second layer of the resin without the filler on one side of the second part;
inserting the first and second parts in a tool, and
driving a flow drill screw through the first part, the first layer and the second layer, wherein the flow drill screw penetrates completely through the second layer.

2. The method of claim 1 further comprising:
forming the second part in a compression molding die by:
placing the filler that includes a fiber reinforcement in the compression molding die; and
depositing the resin into the compression molding die.

3. The method of claim 2 further comprising providing a textured surface on a predetermined portion of the compression molding die where the second layer is formed, wherein the textured surface inhibits the filler from becoming part of the second layer.

4. The method of claim 2 wherein the step of depositing the resin into the compression molding die is performed in two steps, in one step the resin is deposited in the compression molding die to encase the filler in the first layer and in another step the resin is deposited in the compression molding die in the second layer.

5. The method of claim 1 wherein the second layer is more than 3 microns thick.

6. An assembly comprising:
a first part;
a second part having a first layer of a resin that is reinforced with a filler and a second layer of a resin without the filler on at least part of one side of the second part; and
a flow drill screw extending through the first part and the second part.

7. The assembly of claim 6 wherein the second layer is provided in localized areas on the first layer where the flow drill screw is driven into the assembly.

8. The assembly of claim 6 wherein the second layer defines voids across areas of the first layer.

9. The assembly of claim 6 wherein the filler is a fiber reinforcement that is randomly deposited in first layer of the resin.

10. The assembly of claim 6 wherein the resin is selected from a group consisting of:
a thermoplastic resin; and
a thermoset resin.

11. The assembly of claim 6 wherein the filler is selected from a group consisting of:
carbon fiber;
glass fiber;
mica; and
natural fiber.

12. A method comprising:
selecting a first part;
selecting a second part including a first layer of a resin reinforced with a filler and a second layer of the resin without the filler on a back side of the second part;
inserting the first and second parts in a tool, and
clinching the first and second parts together by driving a clinch punch into the first part and the second part with a die engaging the back side of the second part, wherein the second layer inhibits the filler in the first layer from breaking through the back side of the second part.

13. The method of claim 12 further comprising:
forming the second part in a compression molding die by:
placing the filler that includes a fiber reinforcement in the compression molding die; and
depositing the resin into the compression molding die.

14. The method of claim 13 further comprising providing a textured surface on a predetermined portion of the compression molding die where the second layer is formed, wherein the textured surface inhibits the filler from becoming part of the second layer.

15. The method of claim 13 wherein the step of depositing the resin into the compression molding die is performed in two steps, in one step the resin is deposited in the compression molding die to encase the filler in the first layer and in another step the resin is deposited in the compression molding die in the second layer.

16. An assembly comprising:
a first part;
a second part having a first layer of a resin that is reinforced with a filler and a second layer of the resin without the filler on at least part of one side of the second part; and
a clinch joint formed between the first part and the second part wherein the filler in the first layer is inhibited from breaking through the second layer by the second layer.

17. The assembly of claim 16 wherein the second layer is provided in localized areas on the first layer where the clinch joint is formed.

18. The assembly of claim 16 wherein the second layer defines voids across areas of the first layer.

19. The assembly of claim 16 wherein the filler is a fiber reinforcement that is randomly deposited in the first layer of the resin.

20. The assembly of claim 16 wherein the filler is selected from a group consisting of:
carbon fiber;
glass fiber;
mica; and
natural fiber.
